(19) United States
(12) Patent Application Publication
(10) Pub. No.: US 2007/0168328 A1
(43) Pub. Date: Jul. 19, 2007

(54) Intelligent space tube optimizer

(75) Inventors: Richard C. Peralta, Hyde Park, UT (US); Ineke M. Kalwij, Mission (CA)

Correspondence Address: UTAH STATE UNIVERSITY;TECHNOLOGY COMMERCIALIZATION OFFICE, 570 RESEARCH PARK WAY, SUITE 101, NORTH LOGAN, UT, 84341, US

(73) Assignee: Utah State University

(21) Appl. No.: 11/650,173

(22) Filed: Jan. 5, 2007

Related U.S. Application Data
(60) Provisional application No. 60/756,307, filed on Jan. 5, 2006.

(51) Int. Cl. G06F 17/30

(52) U.S. Cl. 707/2

(57) ABSTRACT

This disclosure presents the Intelligent Space Tube Optimization (ISTO) method for developing computationally optimal designs or strategies. ISTO is especially valuable if predicting system response to the design or strategy is computationally intensive, and many predictions are needed in the optimization process. ISTO creates adaptively evolving multi-dimensional decision space tube(s), develops or trains surrogate simulators for the space about the tube(s), performs optimization about the tube(s) using primarily the surrogate simulators and selected optimizer(s), and then can revert to an original simulator for efficient final optimizations. A space tube consists of overlapping multi-dimensional subspaces, and lengthens in the direction of the optimal solution. The space tube can shrink or expand to aid convergence and escape from local optima. ISTO can employ any appropriate type of surrogate simulator and can employ any type of optimizer. ISTO includes a multiple cycling approach. One ISTO cycle involves: (i) defining the multi-dimensional space tube; (ii) generating strategies about the space tube's subspace; (iii) simulating system response to the strategies using an original simulator; (iv) developing or training surrogate simulators, such as regression equations or ANNs; (v) performing optimization about the subspace, primarily using the substitute simulators; (vi) analyzing the optimal strategy; and (vii) evaluating whether space tube radius (radii) modification is required. Based on optimization performance or to escape from a locally optimal solution, the ISTO automatically adjusts the space tube dimensions and location. ISTO cycling terminates per stopping criterion. After cycling terminates, ISTO can proceed to optimize while employing an original simulator, rather than the surrogate. This feature is useful because when optimization problem constraints become extremely tight, predictive accuracy becomes increasingly important.

### RELATED APPLICATIONS

This application claims priority to U.S. patent application Ser. No. 60/756,307 filed on Jan. 5, 2006, entitled “Intelligent Space Tube Optimizer”, and is incorporated herein by reference.

### TECHNICAL FIELD

This present invention relates to methods and devices for simulation optimization.

### BACKGROUND

Developing mathematically optimal designs or management strategies requires the ability to predict system response to a considered design or strategy. If an optimization problem and approach requires many predictive simulations, developing a mathematically optimal strategy using standard methods can require much more computation time than is desirable.

The disclosed Intelligent Space Tube Optimization (ISTO) device and method is especially valuable for reducing the computational time required to solve complex nonlinear optimization problems. ISTO is applicable to many types of problems involving system simulation and optimization. Herein, we demonstrate an embodiment of ISTO for creating optimal groundwater contamination remediation pump and treat (PAT) designs and strategies. Often, a single contamination prediction simulation can take several hours, and optimization usually requires many simulations. For this and other nonlinear optimization problems, ISTO is a valuable method for speeding the creation of mathematically optimal strategies for either serial or parallel processing.

Many problems (groundwater remediation being only one illustrative example) can be highly nonlinear and mathematically complex. Often, they are best solved via heuristic optimization techniques, because those more easily accommodate discontinuities and nonlinearities than pure gradient search techniques. Some of the most commonly used algorithms are genetic algorithms (GA), and simulated annealing (SA). GA, SA (and hybrids) have been extensively applied for solving groundwater management problems.

Shortcomings of such heuristic optimization approaches include the lack of guaranteed convergence to a globally optimal solution for large nonlinear problems, especially within a reasonable number of simulations. Furthermore, heuristic optimizers can converge slowly when applied to large complex problems.

To speed convergence within optimization, one can use substitute (surrogate) simulators (statistically-based equations, artificial neural networks, fuzzy logic, support vector machines, hybrid surrogate models, machine learning, computational intelligence, etc.), that require less computational time to run than the original simulators. Using surrogates can significantly reduce the computer time required for simulating system response to management.

ISTO can employ any surrogate simulator, but preferably would use one that runs significantly more quickly than the original simulator, and is reasonably accurate. Herein we demonstrate an ISTO application using artificial neural networks (ANNs).

ANNs were developed by analogy to the collective processing behavior of neurons in the human brain. ANNs descriptions are known to those skilled in the art.

In groundwater optimization, ANNs trained to predict head, flow, and concentration system response to stimuli are used as substitutes for standard flow and transport simulation models. ANN training involves iteratively feeding the ANN with data sets consisting of pumping strategies and corresponding state variable values.

Training determines values of weights in ANN functions per training rule, most commonly the back propagation algorithm. Back propagation is essentially an iterative nonlinear optimization approach using gradient descent search over the error surface. The error surface is the sum of squared error between predicted and target values for a number of observations.

ANNs are more flexible than conventional nonlinear programming approaches. However, ANNs can only predict accurately for the problem dimensions defined by the simulation model runs used to train them. Changing the problem dimensions requires retraining ANNs using simulations for the new dimensions. Also, if ANNs are not trained with sufficient accuracy, errors will occur in the optimization and sensitivity analysis step.

The major advantage of using substitute simulators (regression equations, ANNs, etc.) is computational time reduction. A potential disadvantage is that inaccurate surrogates can cause errors in optimizations. Further, large-scale, real-world, multiple-stress period problems can require hundreds or thousands of simulations to develop or train adequately accurate surrogates. If each simulation requires much time, surrogate use can become less desirable due to the time required to create the data for preparing accurate surrogates. Efficient optimization techniques are especially important for real problem sites when optimization has to be performed within limited time, not allowing sufficient time to explore all possible well locations (and the entire solution space).

To address the above need, we disclose the Intelligent Space Tube Optimizer (ISTO). ISTO is applicable to any type of problem that requires optimization, but is especially valuable if the employed optimization approach requires many time-consuming predictive simulations. ISTO uses a surrogate simulator to greatly speed convergence to an optimal solution.

### SUMMARY OF THE INVENTION

This disclosure presents the Intelligent Space Tube Optimization (ISTO) method for developing computationally optimal designs or strategies. ISTO is especially valuable if predicting system response to the design or strategy is computationally intensive, and many predictions are needed in the optimization process. ISTO creates adaptively evolving multi-dimensional decision space tube(s), develops or trains surrogate simulators for the space about the tube(s), performs optimization about the tube(s) using the surrogate simulators and selected optimizer(s), and then can revert to an original simulator for efficient final optimizations.

Although ISTO can use any surrogate simulator and optimizer, we demonstrate ISTO using ANNs as surrogate simulators, and using a heuristic optimizer. ISTO significantly reduces the required number of simulations to train ANNs, and avoids potential ANN inaccuracy by defining and adaptively controlling the ANN-training subspace.

ISTO efficiently converges to optimal solutions for assumed and real simulation management problems. For an assumed problem, we disclose how the initially selected space tube radii affect convergence to optimality. We contrast ISTO performance versus performance of a coupled genetic algorithm-tabu search (GA-TS) approach.

We compare ISTO with GA-TS because the latter is about 70% to 90% computationally more efficient than a standard GA and far superior to classical optimization techniques for highly nonlinear systems. A standard GA includes operations such as parent selection, crossover, mutation, and elitism. GA-TS has those plus tabu search features. Just as ISTO can be compared with other optimization techniques, ISTO can employ other surrogate simulators and optimization algorithms.

ISTO can employ any appropriate type of surrogate simulator. Examples include statistically-based regression equations, interpolation functions, artificial neural networks, fuzzy logic, support vector machines, hybrids, machine learning, computational intelligence, etc. ISTO can also employ any sort of optimization algorithm. Examples are classical operations research techniques (such as gradient search, outer approximation, or other methods), heuristic methods (such as genetic algorithm (GA), simulated annealing (SA), tabu search (TS), hybrids, etc.), decision-tree, computational intelligence, or other techniques.

ISTO is appropriate for a range of processing environments. It is here demonstrated using serial processing on a single processor. It is even more effective in a parallel processing environment where multiple simulations and optimizations can be performed simultaneously.

ISTO includes:
Phase 1. A multiple cycling approach in which one ISTO cycle involves: (i) defining the multi-dimensional space tube; (ii) generating strategies about the space tube's subspace; (iii) simulating system response to the strategies using an original simulator; (iv) developing or training surrogate simulators, such as regression equations or ANNs; (v) performing optimization about the subspace, using the substitute simulators; (vi) analyzing the optimal strategy; and (vii) evaluating whether space tube radius (radii) modification is required. A space tube consists of overlapping multi-dimensional subspaces, which lengthens in the direction of the optimal solution (parts of the space tube used in early surrogate development might or might not be used in later surrogate development, depending on the situation). Based on optimization performance, ISTO automatically adjusts the space tube radius or radii (there can be one radius and one decision space dimension per decision variable). ISTO cycling terminates per stopping criterion.
Phase 2. After the Phase 1 cycling terminates, ISTO can proceed automatically to optimization that employs an original simulator, rather than the surrogate. This feature is useful because when optimization problem constraints become extremely tight, predictive accuracy becomes increasingly important. Developing such accuracy in the surrogates requires increasing numbers of preparatory simulations (for example, to prepare the regression equations or ANNs). Thus, refining an optimal strategy can be done using the original simulator.

Herein we demonstrate an embodiment of ISTO for developing optimal PAT system designs and pumping strategies for groundwater contamination remediation. In this embodiment of ISTO implementation, the surrogate simulators are ANNs, and the optimizer is genetic algorithm (GA).

Multiple applications to a complex field site show that ISTO causes much faster objective function improvement than GA-TS alone. Using appropriate input parameters, both methods were applied to develop optimal pumping strategies for managing the example trichloroethylene (TCE) and trinitrotoluene (TNT) plumes. ISTO converges more efficiently—requiring an average of 24% less computational time than GA-TS to get within 10% of the globally optimal solution. In the demonstrative example ISTO improves the initial strategy by 46%, with 42% occurring during ISTO Phase 1.

ISTO efficiently converges to optimal solutions and is computationally more efficient than a very efficient GA-TS for optimizing transient pumping rates for complex nonlinear optimization problem. ISTO is a practical optimization approach for screening different decision variables and combinations, especially if the predictive simulator requires much computational time, and there is limited time available for developing an optimal design or strategy.

### DESCRIPTION OF THE FIGURES

FIG. 1. Flow diagram for ISTO.

FIG. 2. Example space tube movement towards optimal solution.

FIG. 3. Hypothetical study area with initial Species 1 and 2 concentrations in Layers 1 and 2.

FIG. 4. Effect of different sub-space radii on ISTO convergence, expressed in number of simulations.

FIG. 5. Initial TCE and TNT concentrations exceeding 5.0 ppb and 2.8 ppb, respectively, in Layer 3, and part of finite difference grid.

FIG. 6. Non-dimensional representation of ISTO and GA-TS objective function evolution with respect to time.

FIG. 7. Steps performed in ISTO for one space tube and serial processing on single processor.

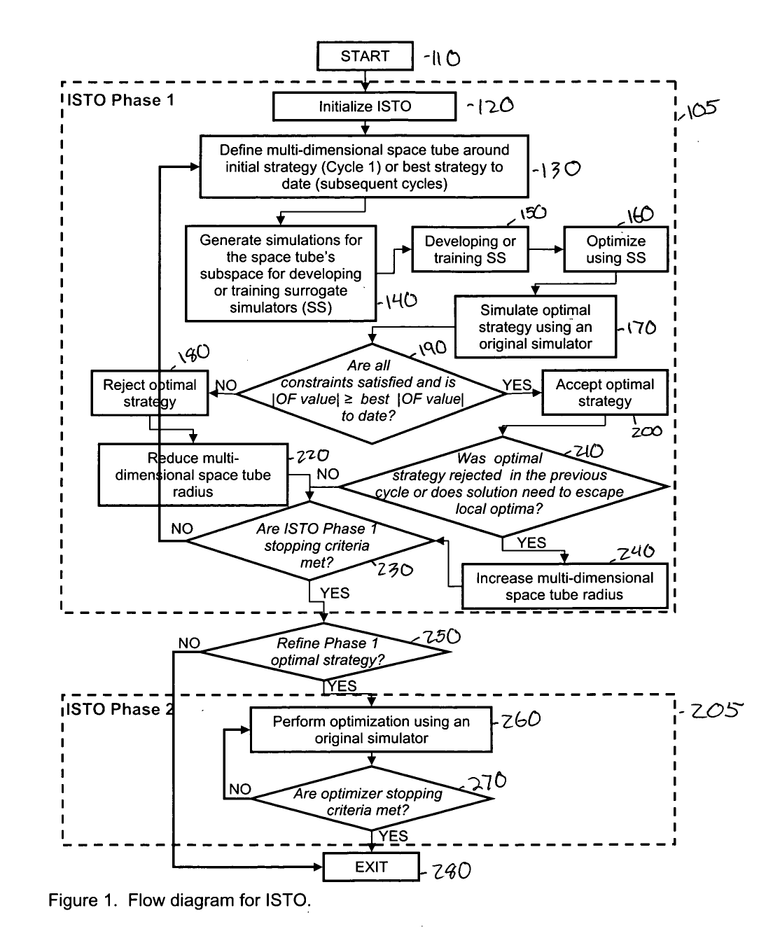

### DETAILED DESCRIPTION OF THE INVENTION

This disclosure presents the Intelligent Space Tube Optimization (ISTO) device and method that reduces the number of real simulations needed for developing optimal strategies for highly nonlinear problems and is especially valuable if: (1) the initial predictive simulator(s) take(s) a long time to run, and (2) the employed optimization approach requires many predictive simulations. ISTO develops or trains surrogate simulators for an adaptive multidimensional decision space tube. While optimizing within the evolving space tube(s), ISTO optimization algorithms primarily call the substitute simulators.

ISTO surrogate simulators can be any sort of adequate predictor, interpolator, or extrapolator. Examples are statistical regression equations, artificial neural networks (ANNs), fuzzy logic, support vector machines, hybrids, machine learning, computational intelligence, etc. ISTO can employ any type of optimizer. Some examples include classical techniques (such as gradient search or outer approximation), heuristic methods (such as genetic algorithm (GA), simulated annealing (SA), tabu search (TS), hybrids, etc.), or other techniques. ISTO is appropriate for processing environments ranging from serial or parallel processing on a single processor to parallel processing on multiple processors simultaneously. Parallel processing facilitates employing multiple space tubes simultaneously.

ISTO processing for a single processor and one space tube is as follows:
Phase 1. In Phase 1 105, which occupies most of an optimization run, ISTO uses a surrogate simulator to significantly reduce total optimization computation time. ISTO Phase 1 105 is a multiple-cycle approach. One cycle involves: (i) defining a multi-dimensional space tube 130, 920; (ii) generating strategies about the space tube's subspace 120, 930; (iii) simulating system response to the strategies using an original simulator 170, 930; (iv) developing or training surrogate simulators 150, 940; (v) performing optimization about the subspace using the substitute simulators 160, 950; (vi) analyzing the optimal strategy 960; and (vii) evaluating whether space tube radius (radii) modification is required 220, 240, 970. A space tube consists of overlapping multi-dimensional subspaces and lengthens in the direction of the optimal solution (parts of the space tube used in early surrogate development might or might not be used in later surrogate development, depending on the situation). Based on optimization performance, ISTO automatically adjusts the space tube radii 220, 240 (there can be one radius per decision-space dimension). ISTO cycling terminates per stopping criterion 230, 980.
Phase 2 205. In Phase 2 205, where optimization problem constraints are so tight that surrogate simulator relative inaccuracy can reduce computational efficiency, ISTO employs the initial, assumedly accurate, simulator. After Phase 1 105 cycling terminates, ISTO can proceed automatically to Phase 2. In Phase 2 optimization problem constraints are often extremely tight, and predictive accuracy becomes increasingly important. Developing high accuracy in the surrogates would require increasing numbers of preparatory simulations (for example, simulations using the original simulator to prepare input-output data to create regression equations or ANNs). Therefore, rather than using the surrogate simulator, ISTO can use the original simulator with a selected optimizer to finish refining an optimal strategy 260, 990.

Regression analysis models the relationship between one or more response variables (also called dependent variables, explained variables, predicted variables, or regressands usually named Y), and the predictors (also called independent variables, explanatory variables, control variables, or regressors usually named X₁, . . . ,Xₚ). Multivariate regression describes models that have more than one response variable.

Simple linear regression and multiple linear regression are related statistical methods for modeling a relationship between two or more random variables using a linear equation. Simple linear regression refers to a regression on two variables while multiple regression refers to a regression on more than two variables. Linear regression assumes the best estimate of the response is a linear function of some parameters (though not necessarily linear on the predictors).

If the relationship between the variables being analyzed is not linear in parameters, a number of nonlinear regression techniques may be used to obtain a more accurate regression.

Maximum likelihood is one method of estimating the parameters of a regression model, which behaves well for large samples. However, for small amounts of data, the estimates can have high variance or bias. Bayesian methods can also be used to estimate regression models. An a priori distribution is assigned to the parameters, which incorporates everything known about the parameters. (For example, if one parameter is known to be non-negative, a non-negative distribution can be assigned to it.) An a posteriori distribution is then obtained for the parameter vector. Bayesian methods have the advantages that they use all the information that is available. They are exact, not asymptotic, and thus work well for small data sets if some contextual information is available to be used in the a priori distribution.

An artificial neural network (ANN), commonly just termed a neural network (NN), is an interconnected group of artificial neurons that uses a mathematical model or computational model for information processing based on a connectionist approach to computation. In most cases an ANN is an adaptive system that changes its structure based on external or internal information that flows through the network.

In more practical terms neural networks are non-linear statistical data modeling tools. They can be used to model complex relationships between inputs and outputs or to find patterns in data.

Training a neural network model essentially means selecting one model from the set of allowed models (or, in a Bayesian framework, determining a distribution over the set of allowed models) that minimizes the cost criterion. There are numerous algorithms available for training neural network models, most of which can be viewed as a straightforward application of optimization theory and statistical estimation.

Most of the algorithms used in training artificial neural networks employ some form of gradient descent. This is done by simply taking the derivative of the cost function with respect to the network parameters and then changing those parameters in a gradient-related direction. Evolutionary methods, simulated annealing, expectation-maximization, and non-parametric methods are among other commonly used methods for training neural networks.

Fuzzy logic is derived from fuzzy set theory dealing with reasoning that is approximate rather than precisely deduced from classical predicate logic. It can be thought of as the application side of fuzzy set theory dealing with well thought-out real-world expert values for a complex problem. Degrees of truth are often confused with probabilities. However, they are conceptually distinct—fuzzy truth represents membership in vaguely defined sets, not likelihood of some event or condition. Fuzzy sets are based on vague definitions of sets, not randomness. Fuzzy logic allows for set membership values between and including 0 and 1, and in its linguistic form, imprecise concepts like “slightly”, “quite” and “very”. Specifically, it allows partial membership in a set.

Support vector machines (SVMs) are a set of related supervised learning methods used for classification and regression. They belong to a family of generalized linear classifiers. A special property of SVMs is that they simultaneously minimize the empirical classification error and maximize the geometric margin.

As a broad subfield of artificial intelligence, machine learning is concerned with the development of algorithms and techniques that allow computers to “learn”. At a general level, there are two types of learning: inductive, and deductive. Inductive machine learning methods create computer programs by extracting rules and patterns out of massive data sets. Some parts of machine learning are closely related to data mining. Machine learning overlaps heavily with statistics. In fact, many machine learning algorithms have been found to have direct counterparts in statistics.

In software programming, a hybrid intelligent system denotes a software system which employs, in parallel, a combination of artificial intelligence (AI) models, methods and techniques from artificial intelligence subfields.

Additional methods are known by those skilled in the art and are equivalents to the prediction, interpolation, or extrapolation methods described. The above descriptions of prediction, interpolation, or extrapolation methods, including preferred embodiments contained herein, are to be construed as merely illustrative and not a limitation of the scope of the present invention in any way. It will be obvious to those having skill in the art that many changes may be made to the details of the above-described embodiments without departing from the underlying principles of the invention. It will be appreciated that the methods mentioned or discussed herein are merely examples of means for performing prediction, interpolation, or extrapolation, and it should be appreciated that any means for performing prediction, interpolation, or extrapolation which performs functions the same as, or equivalent to, those disclosed herein are intended to fall within the scope of a means for prediction, interpolation, or extrapolation, including those means or methods for prediction, interpolation, or extrapolation which may become available in the future. Anything which functions the same as, or equivalently to, a means for prediction, interpolation, or extrapolation falls within the scope of this element.

Evolutionary algorithms (EAs) are search methods that utilize a form of natural selection and survival of the fittest. EAs differ from more traditional optimization techniques in that they involve a search from a “population” of solutions, not from a single point. Each iteration of an EA involves a competitive selection that weeds out poor solutions. The solutions with high “fitness” are “recombined” with other solutions by swapping parts of a solution with another. Solutions are also “mutated” by making a small change to a single element of the solution. Recombination and mutation are used to generate new solutions that are biased towards regions of the space for which good solutions have already been seen. Pseudo-code for a genetic algorithm is as follows:

Initialize the population

Evaluate initial population

Repeat

Perform competitive selection

Apply genetic operators to generate new solutions

Evaluate solutions in the population

Until some convergence criteria is satisfied

There are many types of evolutionary search methods. Some include (a) genetic programming (GP), which evolve programs, (b) evolutionary programming (EP), which focuses on optimizing continuous functions without recombination, (c) evolutionary strategies (ES), which focuses on optimizing continuous functions with recombination, and (d) genetic algorithms (GAs), which focuses on optimizing general combinatorial problems.

EAs are often viewed as global optimization methods although convergence to a global optimum is only guaranteed in a weak probabilistic sense. However, an EA strength is that they perform well on “noisy” functions where there may be multiple local optima. EAs tend not to get “stuck” on local minima and can often find globally optimal solutions. EAs are well suited for a wide range of combinatorial and continuous problems, though the different variations are tailored towards specific domains:
GPs are well suited for problems that require determination of a function that can be simply expressed in a function form.
ES and EPs are well suited for optimizing continuous functions.
GAs are well suited for optimizing combinatorial problems (though they have occasionally been applied to continuous problems).

The recombination operation used by EAs requires that the problem can be represented in a manner that makes combinations of two solutions likely to generate interesting solutions. Consequently selecting an appropriate representation is a challenging aspect of applying these methods.

EAs have been successfully applied to a variety of optimization problems such as wire routing, scheduling, traveling salesman, image processing, engineering design, parameter fitting, computer game playing, knapsack problems, and transportation problems. The initial formulations of GP, ES, EP and GAs were applied to unconstrained problems. Although most research on EAs continues to address unconstrained problems, a variety of methods have been proposed for handling constraints.

Simulated annealing (SA) is a generalization of a Monte Carlo method for examining the equations of state and frozen states of n-body systems. The concept is based on the manner in which liquids freeze or metals re-crystallize in the process of annealing. In an annealing process a melt, initially at high temperature and disordered, is slowly cooled so that the system at any time is approximately in thermodynamic equilibrium. As cooling proceeds, the system becomes more ordered and approaches a “frozen” ground state at T=0. Hence the process can be thought of as an adiabatic approach to the lowest energy state. If the initial temperature of the system is too low, or cooling is insufficiently slow, the system may become quenched forming defects or freezing out in metastable states (ie. trapped in a local minimum energy state).

The original SA scheme was that an initial state of a thermodynamic system was chosen at energy E and temperature T, holding T constant the initial configuration is perturbed and the change in energy dE is computed. If the change in energy is negative the new configuration is accepted. If the change in energy is positive it is accepted with a probability given by the Boltzmann factor exp−(dE/T). This processes is then repeated sufficient times to give good sampling statistics for the current temperature, and then the temperature is decremented and the entire process repeated until a frozen state is achieved at T=0.

By analogy the generalization of this Monte Carlo approach to combinatorial problems is straightforward. The current state of the thermodynamic system is analogous to the current solution to the combinatorial problem, the energy equation for the thermodynamic system is analogous to the objective function, and the ground state is analogous to the global minimum. The major difficulty in SA algorithm implementation is that there is no obvious analogy for the temperature T with respect to a free parameter in the combinatorial problem. Furthermore, avoidance of entrainment in local minima (quenching) is dependent on the “annealing schedule”, the initial temperature, number of iterations performed at each temperature, and the amount the temperature is decremented at each step as cooling proceeds.

Simulated annealing has been used in various combinatorial optimization problems and has been particularly successful for circuit design problems.

Additional methods, such as Simplex, MIP, LP, NLP, MNLP, and MINLP are known by those skilled in the art and are equivalents to the optimization methods described. The above descriptions of optimization methods, including preferred embodiments contained herein, are to be construed as merely illustrative and not a limitation of the scope of the present invention in any way. It will be obvious to those having skill in the art that many changes may be made to the details of the above-described embodiments without departing from the underlying principles of the invention. It will be appreciated that the methods mentioned or discussed herein are merely examples of means for performing optimization, and it should be appreciated that any means for performing optimization which performs functions the same as, or equivalent to, those disclosed herein are intended to fall within the scope of a means for optimization, including those means or methods for optimization which may become available in the future. Anything which functions the same as, or equivalently to, a means for optimization falls within the scope of this element.

ISTO can be applied to many types of optimization problems. Here it is demonstrated by application to optimizing groundwater contamination remediation—a nonlinear problem often having extensive predictive simulation times and usually addressed using heuristic optimizers.

ISTO includes multiple cycles. Each cycle includes the steps: (1) initializing ISTO with a solution strategy 120, 930; (2) defining the multi-dimensional space tube (subspace) 130, 920; (3) generating simulations (used for creating or training surrogate simulator) within the subspace 140, 930; (4) preparing surrogate simulators 150, 940; (5) performing optimization that uses the surrogate simulators 160, 950; (6) analyzing the optimal strategy, computed in step 5, concerning objective function value and constraint violations 190, 210, 960; (7) evaluating whether space tube radius modification is required 220, 240, 970; and (8) evaluating stopping criteria 230, 980. Step 9, optimization using the original simulator(s) 260, 990, refines the optimal strategy developed during the previous steps.

Step 2 920 creates a space tube, consisting of overlapping multi-dimensional subspaces, that forms a subspace of the total solution space. Conceptually, the solution space size is artificially bounded to form a space tube that lengthens in the direction of the optimal solution. To avoid exploring the entire solution space, ISTO generates new strategies within and near the leading portion (head) of the space tube. The space tube 410 is defined around the initial strategy (first cycle) or best strategy to date (subsequent cycles). Space tube radii define temporary artificial lower and upper bounds on each decision variable and they equal a percentage of the range between the original lower and upper bounds. Bounds of variables in the original optimization problem define the entire solution space.

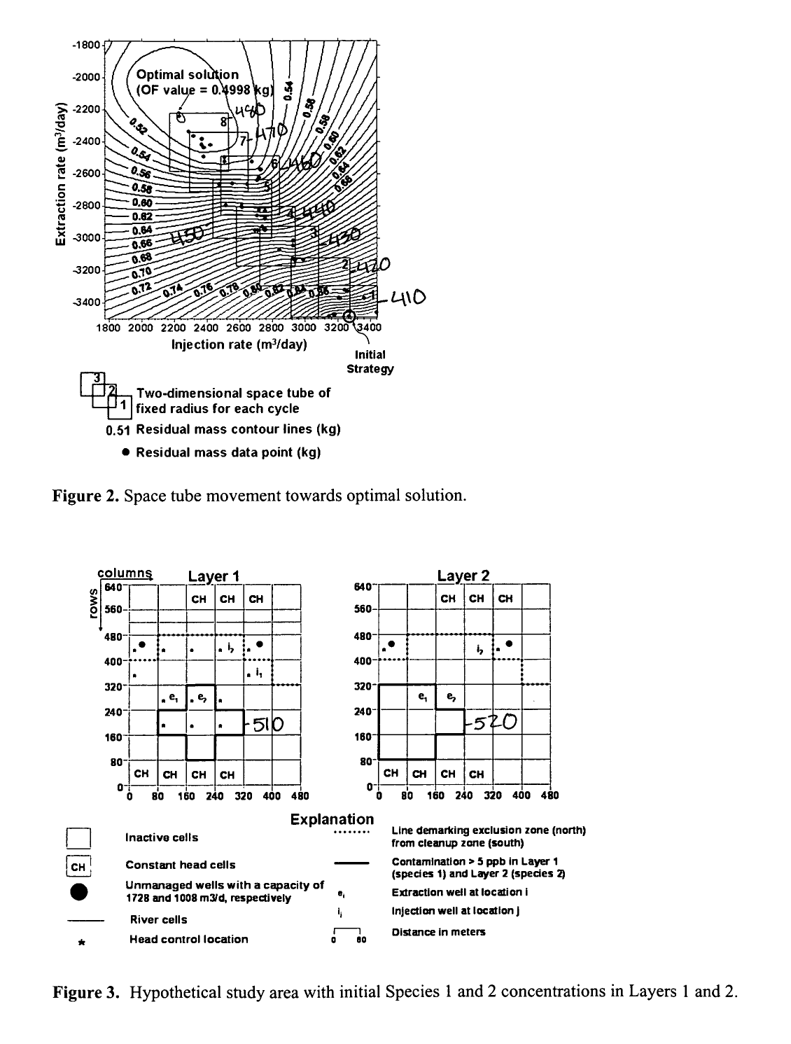

FIG. 2 illustrates cyclical space tube evolution 410-480 for the assumed example problem that minimizes residual contaminant mass subject to 5 ppb cleanup and containment constraints. The problem uses two injection and two extraction wells. Because both total injection and total extraction are fixed, the solution space can be displayed two-dimensionally. The figure illustrates that ISTO converges within eight cycles to an optimal solution.

FIG. 2 also illustrates that the solution subspaces overlap and that a strategy generated in a previous subspace can also lie in the next subspace. In this figure the space tube radius is fixed to be the same value for every cycle. However, ISTO can adaptively shrink or expand the space tube radius based on performance and can increase the radius(ii) if appropriate to escape from a local optimum.

In Step 7 970 ISTO evaluates whether the space tube radius should be modified for the next cycle, and makes the modification 220, 240. ISTO can employ any desired modification method. For illustration here, the space tube radius is reduced if, in Step 6, the optimal strategy is rejected 220. If the optimal strategy is accepted in Step 6, but was rejected in the previous cycle, the radius is increased 240. In other words, the space tube radius is reset to a value close to the radius at the start of the previous cycle. Magnitude of space tube radius expansion and reduction are functions of ANN accuracy:
R_{new}=R_{old}−ΔR(solution space reduction) (1a)
R_{new}=R_{old}+ΔR(solution space expansion) (1b)
ΔR=βΔR_{old}+(1−β)ΔR_{new} (1c)
ΔR_{new}=MAX(ε)R_{old} (1d)

where: R and ΔR are the space tube radius and change in space tube radius, respectively, with “new” and “old” referring to newly and previously computed values. The change in solution space radius (ΔR) is computed based on the previously computed change in radius (ΔR_{old}) and the newly computed change (ΔR_{new}), whereby ΔR_{new} is a function of the old space tube radius and the maximum error (ε), or difference occurring between the predicted and simulated state variable value, computed in Step 6 (ε is bounded to prevent either too small or too large solution space changes). Parameter β (0≦β<1) controls how much ΔR is based on ΔR_{old} and ΔR_{new}; β=0 means that change in solution space radius only depends on ΔR_{new}.

In some situations it might be appropriate to occasionally significantly expand the space tube radius(ii) to allow escape from a potential local optimum. If trial expansion does not yield a better solution, solution space reduction continues.

Step 8 980 determines whether ISTO continues using surrogate simulators in optimization, switches to the original simulators, or halts. In Step 9, ISTO switches to using original simulators and can change optimizers to refine the optimal strategy resulting from Steps 2-7 cycling. Step 9 990 is valuable if constraints are so tight that surrogate simulator accuracy becomes inadequate. Step 9 is continued until a stopping criterion is satisfied 270 (an example is completion of a specified number of simulations).

Example Ground Water Management Applications

I. Effect of the Initial Space Tube Radius on ISTO Performance

Assume a 0.31 km² (76 acres) two-layer river-aquifer system in which groundwater is contaminated by two different non-reactive contaminants (FIG. 3). Assume instantaneous mixing of a contaminant with groundwater throughout any contaminated cell. Aquifer Layer 1 is unconfined with a thickness of about 20 m, and Layer 2 is a 10 m thick confined aquifer. Recharge enters the area horizontally through constant head cells and constant flux cells.

For optimization, active cells are assigned to one of two zones both of which extend to the two layers. Zone 1, the exclusion zone, identifies cells in which neither contaminant must exceed 5 parts per billion (ppb) maximum concentration levels (MCL) at times constraints are applied. Zone 2, the cleanup zone, includes cells at which the contamination must be cleaned up to below MCL by the end of management. Two unmanaged drinking water wells pump at 1728 m³/d (317 gpm) and 1008 m³/d (185 gpm), respectively. Both wells fully penetrate Layers 1 and 2. The system is modeled using the MODFLOW finite-difference groundwater flow model and the MT3DMS modular three-dimensional transport model known to those skilled in the art. The model is designed for one stress period and the modeled simulation time is 365 days.

The goal of this example is to minimize total pumping from extraction wells:

$$min {Z}_{1} = {\sum }_{a = 1}^{{N}^{EW}} {α}_{{Q}_{e}} {q}_{{p}_{e}} \\ a = 1 , … , {N}^{EW} \qquad ( 2 )$$

subject to:

$$\begin{matrix}{q}_{{p}_{e}}^{L} \leq {q}_{{p}_{e}} \leq {q}_{{p}_{e}}^{U} & ( 3 ) \\ {q}_{{i}_{e}}^{L} \leq {q}_{{i}_{e}} \leq {q}_{{i}_{e}}^{U} & ( 4 ) \\ {\sum }_{a = 1}^{{N}^{EW}} \vert {q}_{{p}_{e}} \vert = {\sum }_{b = 1}^{{N}^{IW}} {q}_{{i}_{e}} \\ a = 1 , … , {N}^{EW} , b = 1 , … , {N}^{IW} & ( 5 ) \\ {h}_{i , j , k}^{L} \leq {h}_{i , j , k} \leq {h}_{i , j , k}^{U} & ( 6 ) \\ {C}_{s , z , t}^{L} \leq {C}_{s , z , t} \leq {C}_{s , z , t}^{U} & ( 7 )\end{matrix}$$

where α_{Q}_{ₑ} is a weighting coefficient (=−1), qₚ_{ₑ} is the pumping rate at extraction well p at location e (with e indicating a layer, row, and column), qᵢ_{ₑ} is the injection rate at well i at location e, N^{EW} are the total number of extraction wells, N^{IW} are the total number of injection wells, ^{L} denotes the lower bound on a decision variable or constraint, and ^{U} denotes an upper bound on a decision variable or constraint. Here we use two extraction wells and two injection wells (FIG. 3). Equation 5 forces the total extraction rate to equal the total injection rate. Injection and extraction at individual wells cannot exceed 3543 m³/day. In equation 6, h_{i,j,k} is hydraulic head at location i (column), j (row), k (layer). Hydraulic head cannot drop below 13 m. and exceed 19 m. In Equation 7, C_{s,z,t} is the maximum concentration for species in zone z at time t. This problem has two species (Species 1 and 2) and two zones (exclusion and cleanup zones). Concentration cannot exceed 5 ppb in the exclusion zone (z=1) at time=180, 270, and 365 days. Cleanup (<5 ppb) must be achieved at the end of 365 days in the cleanup zone z=2.

We define 6 scenarios (Scenarios A1-A6) 610-660. Each of the 6 scenarios uses a different initial space tube radius (5%, 10%, 15%, 20%, 25%, and 30%, respectively for Scenarios A1-A6) 610-660. Optimization is repeated 10 times for each scenario, yielding a total of 60 optimization runs. These scenarios will demonstrate that ISTO converges in most of the cases, regardless of the size of the initially defined radius (which can affect ISTO computational efficiency).

ISTO is initialized with a pumping strategy that has a total pumping of 3543 m³/day (equaling the maximum capacity of the treatment facility). For all 6 scenarios 610-660 the ISTO employs 10 simulations per cycle to train ANNs, and ISTO cycling terminates (Step 8) 980 after 20 cycles.

After Step 8 980, ISTO automatically proceeds to Step 9 990 or GA-TS optimization. Here GA-TS runs for 45 generations with a generation size of 10 simulations. Except for the initial space tube radius, all other inputs are the same for each scenario.

This analysis evaluates how well ISTO converges to the best solution obtained from post-optimization simulation runs (2909 m³/day), performed without ISTO. For convenience we term that the globally optimal solution. The convergence value equals the percentage difference between the best objective function value achieved for each scenario run, and the globally optimal solution. The smaller the convergence value the closer a run converged to the globally optimal solution. Here we assume a strategy has converged if the objective function value corresponds to a convergence value less than or equal to 0.5% (2923 m³/day).

ISTO always converges within 0.5% of the globally optimal solution for 85% of the 60 runs when initialized with any of the abovementioned initial space tube radii. The additional 15% converges within 1.1% to 1.4%. Poorer convergence of these runs is ascribed to an optimal strategy that has very tight cleanup constraints.

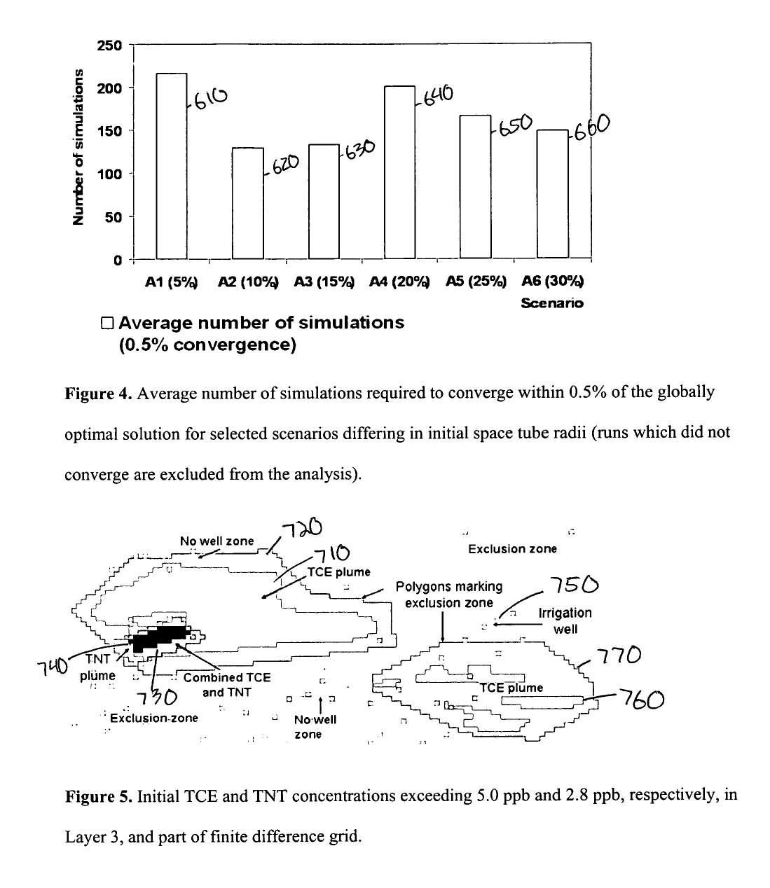

For an 85% of the scenario runs, convergence occurred either during ISTO's ANN-GA phase or during GA-TS optimization, which is invoked after completing twenty ANN-GA cycles. Those 85% of the scenario runs differ in the number of simulations required to reach below 0.5%. FIG. 4 illustrates the average number of simulations required to converge within 0.5% of the globally optimal solution for each scenario (data excludes those runs that did not converge). Selecting a small initial space tube radius can slow the convergence, because the optimizer searches a relatively smaller (multi-dimensional) solution space compared to the use of a larger initial space tube radii. Here selecting a 5% initial space tube radius generally requires more simulations to reach optimality than the other initial radii. However, selecting too large an initial radius occasionally slows the convergence, because of difficulty training ANNs accurately for the (large) solution space when using a small number of simulations as training set. However, the adaptive feature of the ISTO and GA-TS continuation ensures that a run generally converges to the globally optimal solution, even if the initial radius is set at a large value.

II. Solving Example Groundwater Contamination Problem Using ISTO

The example problem has significant groundwater contamination by volatile hydrocarbons (VOC) and explosives from solid waste and explosives disposal and wastewater discharge.

The saturated hydrogeologic units from the ground surface downwards are characterized as unconfined, upper confining, and semi-confined aquifers, of which the latter is the major local water supply aquifer. The unconfined and upper confining layers are discontinuous in certain portions of the study area. The study area includes over 1000 irrigation wells, which operate during summer months. During the non-irrigation season, flow is predominantly to the east and southeast with an average hydraulic gradient of 0.001. The irrigation season significantly affects groundwater flow direction. There is currently no pump-and-treat system installed.

Calibrated MODFLOW and MT3DMS models simulate the groundwater flow and transport related processes (advection, dispersion and chemical reactions of contaminants), respectively. Both models are assumed to accurately represent the groundwater system and processes. Addressing the impact of the simulation models' grid resolution, numerical errors, or uncertainty in any of the aquifer parameters on the optimal solution is beyond the scope of this research.

The model includes 6 layers, 82 rows and 136 columns and covers 357 km² (134 mi²). Layer 1 represents the unconfined aquifer and has an average thickness of 6.8 m. Layer 2, a thin upper confining layer, has an average thickness of 1.1 m. Layers 4-6, which are the semi-confined aquifers, each have an average thickness of 9.5 m. The model is discretized using cell sizes ranging between 122 m×122 m (center cells of the study area) to 610 m×610 m (lateral boundaries of the study area).

Calibrated hydraulic conductivities range from 3 to 24 m/day in the unconfined layer, 0.0006 to 0.2 m/day in the upper confining layer, and 46 to 76 m/day in the semi-confined aquifers. The model has 60 stress periods and a 30-year planning horizon. There are two stress periods per year, of 76 and 289 days coinciding with the irrigation and non-irrigation seasons, respectively.

The transport model is designed for simulating trichloroethylene (TCE) and trinitrotoluene (TNT) plumes (FIG. 5) for layers 1-6. The combined plumes stretch over a length of 12.2 km.

The formulation goal discussed here is to minimize the maximum total remediation pumping in any five-year management period (MP) during a 30-year horizon:
min Z₁=αQₘₐₓ (8)
subject to:
qₚ_{ₑ}^{L}≦qₚ_{ₑ}≦qₚ_{ₑ}^{U} (9)
N^{EW}≦N^{EW}^{_{MAX}} (10)
C_{s,z,t}^{L}≦C_{s,z,t}C_{s,z,t}^{U} (11)
where Qₘₐₓ is the maximum total pumping rate (L³/T) at extraction wells in any five-year management period during the next 30 years and α is a weighting coefficient. Here we use α=0.0051948 which converts the objective function value from cubic feet per year (ft³/yr) to gallons per minute. In Equation 9, qₚ_{ₑ} is the pumping rate at extraction well p at location e (with e indicating a layer, row, and column). ^{L} denotes the lower bound on a decision variable or constraint and ^{U} denotes an upper bound on a decision variable or constraint. Upper bound on pumping is based on the number of layers which a remediation well screens. The pumping limits on wells screened in 1, 2, or 3 layers are 1908 (350 gpm), 3816 (700 gpm), and 5724 (1050 gpm) m³/day, respectively. Wells can be added or pumping rates can be changed at the beginning of each MP (i.e. the beginning of modeling years 1, 6, 11, 16, 21, and 26). N^{EW} is the total number of candidate remediation wells. The maximum number of remediation wells (N^{EW}^{_{MAX}}) is 25. In Equation 11, C_{s,z,t} is the maximum concentration for species s in zone z at time t. This problem has two species (TCE and TNT) and defines an exclusion zone for each of them. Concentration cannot exceed 5 ppb and 2.8 ppb in the exclusion zones for TCE and TNT in Layers 3-6, respectively, and is evaluated at the end of year 5, 10, 15, 20, 25, and 30. Polygons encircling the plumes in FIG. 5 delineate the frontier between the contamination and the surrounding forbidden zones.

Additional modeling features are:
a) No cell should become dry (saturated thickness must always be greater than zero);
b) The 30-year planning period is discretized into six 5-year management periods (MPs), and 60 simulation model stress periods (SPs);
c) Input data includes 60 SPs of time-varying background irrigation pumping rates that are not subject to optimization;
d) Layers 1 and 2 are excluded from optimization.
e) Well installation is not allowed in specified locations, as indicated in FIG. 4.

Optimization is performed simulating TCE only, while maintaining one extraction well located in the TNT plume and imposing a lower bound on pumping from this well to veritably ensure satisfying TNT cleanup and containment constraints. Based on previous optimization efforts we know that TNT containment can be achieved by adding a remediation well in the TNT. Further, optimization is performed using 25 candidate remediation wells. The well locations are known. We only optimize timing and installation of extraction wells and pumping rates for each 5-year MP.

The intent is to demonstrate: (i) ISTO applicability to large-scale, complex, nonlinear transport optimization problems (Scenario B); and (ii) to compare ISTO Scenario B performance to that of an efficient GA-TS optimizer (Scenario C). Here we assume ISTO is not trapped in a local optimum solution and do not significantly expand space tube radius(ii) during convergence.

To provide a better comparison of the stochastic optimization processes, in this demonstration, both ISTO and GA-TS optimizations are repeated three times. ISTO trains six ANNs per cycle. An ANN is trained to predict the maximum contamination concentration value in the forbidden zones at particular times. Because this constraint is evaluated after every management period (i.e. year 5, 10, 15, 20, 25, and 30), six different ANNs are trained. The GA is run for a maximum of 20 generations and calls ANNs as substitute simulators.

Each cycle requires at least six simulations for training ANNs. ISTO is initialized with an initial space tube radius of 14% and a feasible strategy having a 21,744 m³/day (3990 gpm) min-max OF value. ISTO can run up to 40 cycles but can also be terminated earlier via Step 8 if, after Cycle 25, the OF value does not improve within 4 consecutive cycles. After ISTO's ANN-GA phase is terminated, ISTO automatically continues with GA-TS phase (ISTO Step 9 990).

ISTO optimization is performed three times (Scenario B1-B3), with each run using the same input parameters. Total ISTO run time is 22 days (for each run). Results show that ISTO improves the initial strategy by 46%. Table 1 shows that ISTO Phase 1 105 causes an average 42% objective function enhancement, and Phase 2 205 causes an average 4% further enhancement. The objective function value does not improve further because of tightness of the contaminant containment constraints.

The same problem is also solved three times using only GA-TS optimization (Scenarios C1-3) and identical input parameters. GA-TS is initialized with six replicas of the strategy used for initializing ISTO, and each generation consists of 6 simulations. GA-TS optimization is also run for 22 days. Table 2 shows that GA-TS improves the initial strategy by an average of 45%, with optimal results near those of ISTO.

TABLE 1
ISTO Phase 1 (ANN-GA) and Phase 2 (GA-TS) results.

| | | | Percentage improvement | | |
|---|---|---|---|---|---|
| | ISTO's | ISTO's | from initial strategy | | |
| | ANN-GA | GA-TS | (21,744 m³/day) | | |
| Scenario | Phase 1 | Phase 2 | Phase | | Phase |
| run | m³/day (gpm) | m³/day (gpm) | 1 | Increment | 2 |
| B1 | 12,527 | 11,696 | 42.4 | 3.8 | 46.2 |
| | (2298) | (2146) | | | |
| B2 | 12,422 | 11,796 | 42.9 | 2.9 | 45.7 |
| | (2279) | (2164) | | | |
| B3 | 12,851 | 11,726 | 40.9 | 5.2 | 46.1 |
| | (2358) | (2151) | | | |

TABLE 2
GA-TS optimization results (Scenario C).

| | Objective | Improvement from initial |
|---|---|---|
| Scenario | function value | strategy (21,744 m3/day) |
| run | m³/day (gpm) | % |
| C1 | 11,929 (2189) | 45.1 |
| C2 | 11,773 (2160) | 45.9 |
| C3 | 12,147 (2229) | 44.1 |

The main difference between ISTO (Scenario B) and GA-TS (Scenario C) results is how quickly the objective function value improves. Improvement generally occurs much more rapidly using ISTO than GA-TS alone. Table 3 summarizes ISTO and GA-TS convergence values. These values are based on the objective function value and the best objective function value ever obtained previously through optimization (11,554 m³/day, or 2120 gpm). This value was obtained by continuing a GA-TS run for over 5 weeks. For convenience we refer to this as the globally optimal solution.

TABLE 3
Optimization convergence values for ISTO (Scenario
B) and GA-TS (Scenario C) after 22 days run-time.

| | |
|---|---|
| ISTO convergence | GA-TS convergence |

| Scenario | Phase 1 | Phase 2 | Scenario | |
|---|---|---|---|---|
| run | % | % | run | % |
| B1 | 8.4 | 1.2 | C1 | 3.2 |
| B2 | 7.5 | 2.1 | C2 | 1.9 |
| B3 | 11.2 | 1.5 | C3 | 5.1 |

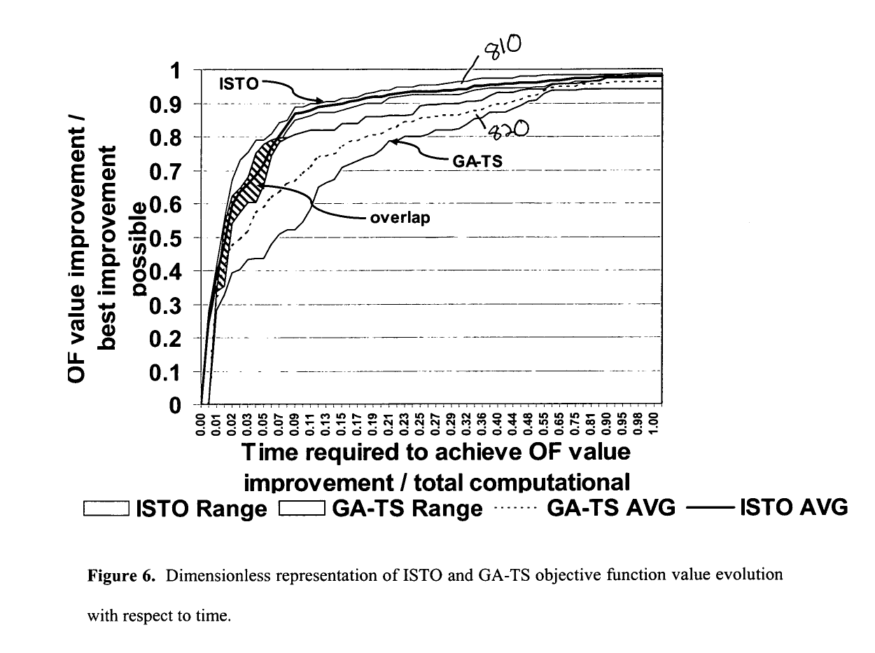

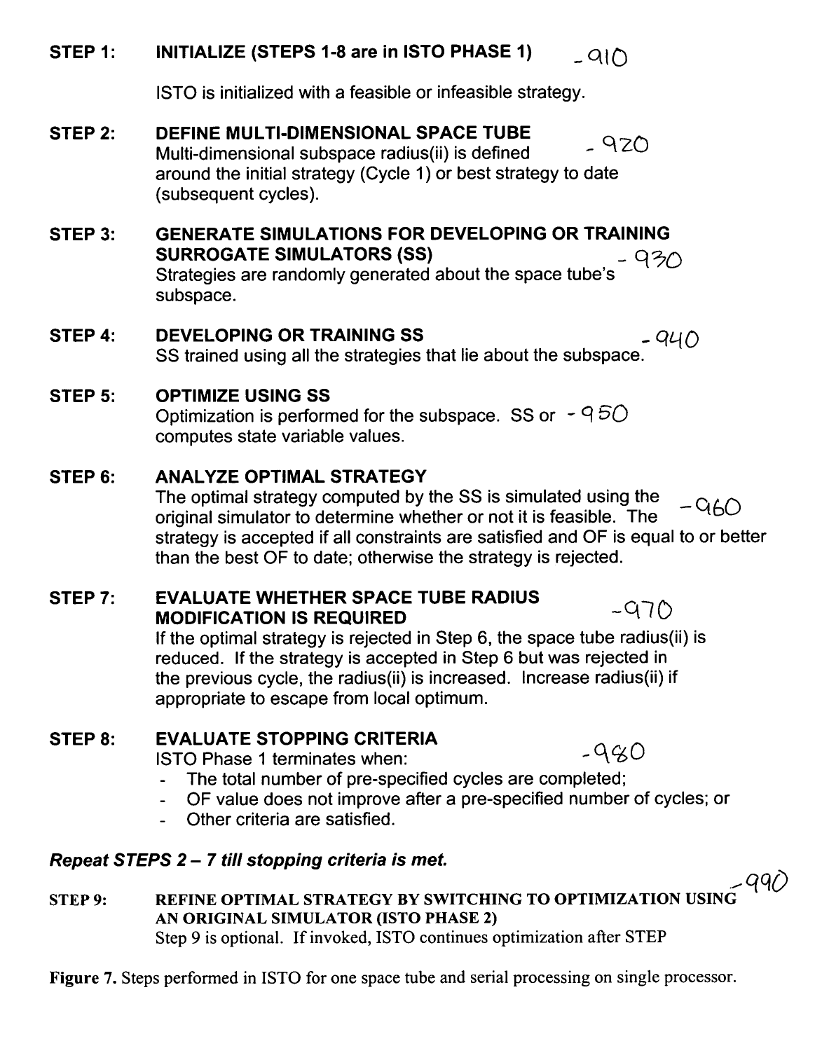

FIG. 6 summarizes the evolution of the objective function value enhancement non-dimensionally. The x-axis represents the ratio between the time required to achieve a particular n objective function value improvement and the total computational time (22 days). The y-axis represents the ratio between the improvement achieved by a simulation and the best improvement possible. The best improvement possible equals 10,190 m³/day (1870 gpm)—the difference between the initial strategy (21,744 m³/day (3990 gpm) and the globally optimal solution. Shaded areas in FIG. 6 represent the ranges in which ISTO data points and GA-TS data points are located, respectively. Figure curves display average values. On the average, to get to within 10% of the globally optimal solution, ISTO converges 25% faster than GA-TS. In other words, on the average, ISTO only requires 16% of the total computational time to converge within 10%, whereas GA-TS requires 41%.

Despite the infinite number of solutions for this type of large nonlinear problem, ISTO can converge efficiently within 10% of the globally optimal solutions. This makes ISTO a useful optimization approach for evaluating different well combinations for large problems when modeling time is limited.

Description of ANN

The demonstrated ISTO application includes MODFLOW and MT3DMS as initial groundwater flow and contaminant transport simulators, respectively; ANNs as surrogate simulators; GA as the optimizer for the decision-space tube; and GA-TS as the final refining optimizer. Each ANN consists of one input layer, one hidden layer, and one output layer. ISTO can accommodate any type of ANN architecture, or surrogate simulator.

For this application, the ANN input layer represents the decision variable vector for one or more management periods (MPs). The pumping rates for individual wells do not change within an MP, but an MP can contain one or more stress periods. If, for example, an optimization problem assumes four MPs, each of which has two stress periods, the ANN architecture is designed based on 4 MPs rather than 8 stress periods—reducing the size of the input vectors compared to an ANN design based on stress periods. ISTO optimizes for multiple MPs or stress periods simultaneously rather than sequentially.

The hidden layer consists of one or more neurons, and the output layer consists of one neuron, representing one state variable. Neurons in the hidden and output layer each have a bipolar sigmoid function with domain [−1,1]. Connection weights (wᵢⱼ) link the input layer to the hidden layer and link the hidden layer to the output neuron. ANN training involves calibrating these weights. For each state variable a separate ANN is trained using supervised learning.

ANN training employs a back propagation (BP) algorithm based on adaptive learning rate and adaptive momentum. The ANNs are linked to a GA optimization solver, which calls ANNs to compute the response to stimuli.

Description of GA-TS

In this demonstration example, ISTO Phase 2 (Step 9) employs a GA-TS hybrid optimizer and the initial simulators to refine the strategy resulting from ISTO's Phase 1 105 (Phase 1 105 optimization employed ANN surrogate simulator and GA optimizer). However, recall that ISTO can use any surrogate simulator and any optimizer in Phase 1 105, as well as in Phase 2. In this demonstration, GA-TS is also used as a stand-alone to provide computational efficiency comparison with ISTO's (Phase 1 105).

The GA-TS hybrid simultaneously optimizes multiple stress periods. The GA component uses operations such as parent selection, crossover, and mutation, and also uses elitism. Elitism refers to selecting elite strategies, which are the best developed strategies to date and are transferred from one GA generation to the next. TS (meta) heuristic component guides the GA to search the solution space more efficiently.

TS is called within a GA generation loop after a new strategy is developed by the GA but before the strategy is simulated. Briefly, TS mechanisms include:
a) Intensifying search in the region of the solution space that potentially yields superior strategies by allowing only GA elite strategies to be parents and by maintaining a tabu list to avoid searching in regions that yield inferior results.
b) Controlling the search coarseness and solution space size. Search coarseness requires a minimum distance between strategies (in L³/T units). The solution space size is the maximum change (in L³/T) in decision variable value for a newly generated strategy with respect to its parents.
c) Evaluating whether the newly developed pumping strategy satisfies a threshold accepting value that forces the optimizer to only simulate a strategy that has an unpenalized objective function value that is better than the objective function value of the best strategy generated so far. This criterion is only applied if the objective function only consists of decision variable based components.

The newly developed strategy is simulated if all the conditions of the applied TS mechanisms are satisfied. However, if any invoked condition is not satisfied, the new strategy is rejected, and a new pumping strategy is developed via mutation.

This specification fully discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

What is claimed is:

1. A computer-implemented apparatus for simulation/optimization, comprising:
a simulation/optimization computational engine;
a surrogate simulation engine;
a memory associated with said simulation/optimization computational engine and with said surrogate simulation engine for storing computation results;
a data storage means for storing said computation results in said memory;
an optimization stopping criterion;
an objective function;
a stopping criteria;
a constraint definition;
a solution strategy;
a definition of a multi-dimensional space tube containing a subspace;
(a) said simulation/optimization computational engine generating simulations within said subspace of said multi-dimensional space tube;
(b) performing optimization using said surrogate simulation engine;
(c) analyzing optimization strategy computed in step (b) concerning valuation of said objective function for said optimization strategy computed in step (b);
(d) analyzing optimization strategy computed in step (b) concerning valuation of said constraint definition for said optimization strategy computed in step (b);
(e) updating said multi-dimensional space tube and subspace by computing a modified multi-dimensional space tube and subspace;
(f) computing an updated solution strategy from optimization strategy computed in step (b);
(g) saving said updated solution strategy and said updated space tube and subspace to said memory;
(h) evaluating said stopping criteria; and
iterating sequence (a) through (h) using said updated solution strategy and updated space tube and subspace as inputs to said computational engine until said stopping criterion is met.

2. The computer-implemented apparatus of claim 1 wherein:
said simulation/optimization computational engine includes a tabu search optimizer.

3. The computer-implemented apparatus of claim 1 wherein:
said simulation/optimization computational engine includes a simulated annealing optimizer.

4. The computer-implemented apparatus of claim 1 wherein:
said simulation/optimization computational engine includes a branch and bound search optimizer.

5. The computer-implemented apparatus of claim 1 wherein:
said simulation/optimization computational engine includes an evolutionary algorithm optimizer.

6. The computer-implemented apparatus of claim 5 wherein:
said evolutionary algorithm optimizer includes a genetic algorithm.

7. The computer-implemented apparatus of claim 5 wherein:
said evolutionary algorithm optimizer includes genetic programming.

8. The computer-implemented apparatus of claim 5 wherein:
said evolutionary algorithm optimizer includes evolutionary strategies.

9. The computer-implemented apparatus of claim 1 wherein:
said surrogate simulation engine includes a statistical regression equation.

10. The computer-implemented apparatus of claim 1 wherein:
said surrogate simulation engine includes an artificial neural network.

11. The computer-implemented apparatus of claim 1 wherein:
said surrogate simulation engine includes a hybrid.

12. The computer-implemented apparatus of claim 1 wherein:
updating said multi-dimensional space tube and subspace by computing a modified multi-dimensional space tube and subspace that lengthens in the direction of the optimal solution.

13. The computer-implemented apparatus of claim 1 wherein:
updating said multi-dimensional space tube and subspace by computing a modified multi-dimensional space tube and subspace that decreases a space tube radius.

14. The computer-implemented apparatus of claim 1 wherein:
updating said multi-dimensional space tube and subspace by computing a modified multi-dimensional space tube and subspace that increases a space tube radius.

15. A computer-implemented apparatus for simulation/optimization, comprising:
a simulation/optimization computational engine;
a surrogate simulation engine;
a memory associated with said simulation/optimization computational engine and with said surrogate simulation engine for storing computation results;
a data storage means for storing said computation results in said memory;
an optimization stopping criterion;
an objective function;
a stopping criteria;
a constraint definition;
a solution strategy;
a definition of a multi-dimensional space tube containing a subspace;
(a) said simulation/optimization computational engine generating simulations within said subspace of said multi-dimensional space tube;
(b) training said surrogate simulation engine using said simulations generated in step (a);
(c) performing optimization using said trained surrogate simulation engine;
(d) analyzing optimization strategy computed in step (c) concerning valuation of said objective function for said optimization strategy computed in step (c);
(e) analyzing optimization strategy computed in step (c) concerning valuation of said constraint definition for said optimization strategy computed in step (c);
(f) updating said multi-dimensional space tube and subspace by computing a modified multi-dimensional space tube and subspace;
(g) computing an updated solution strategy from optimization strategy computed in step (c);
(h) saving said updated solution strategy and said updated space tube and subspace to said memory;
(i) evaluating said stopping criteria; and
iterating sequence (a) through (i) using said updated solution strategy and updated space tube and subspace as inputs to said computational engine until said stopping criterion is met.

16. The computer-implemented apparatus of claim 15 wherein:
said surrogate simulation engine includes an artificial neural network.

17. The computer-implemented apparatus of claim 15 wherein:
said surrogate simulation engine includes a hybrid.

18. The computer-implemented apparatus of claim 15 wherein:
updating said multi-dimensional space tube and subspace by computing a modified multi-dimensional space tube and subspace that lengthens in the direction of the optimal solution.

19. The computer-implemented apparatus of claim 15 wherein:
updating said multi-dimensional space tube and subspace by computing a modified multi-dimensional space tube and subspace that decreases a space tube radius.

20. The computer-implemented apparatus of claim 15 wherein:
updating said multi-dimensional space tube and subspace by computing a modified multi-dimensional space tube and subspace that increases a space tube radius.

21. A method for simulation/optimization, comprising:
a simulation computational process;
a surrogate simulation process;
an optimization stopping criterion;
an objective function;
a stopping criteria;
a constraint definition;
a solution strategy;
a definition of a multi-dimensional space tube containing a subspace;
(a) said simulation computation process generating simulations within said subspace of said multi-dimensional space tube;
(b) performing optimization using said surrogate simulation process;
(c) analyzing optimization strategy computed in step (b) concerning valuation of said objective function for said optimization strategy computed in step (b);
(d) analyzing optimization strategy computed in step (b) concerning valuation of said constraint definition for said optimization strategy computed in step (b);
(e) updating said multi-dimensional space tube and subspace by computing a modified multi-dimensional space tube and subspace;
(f) computing an updated solution strategy from optimization strategy computed in step (b);
(g) evaluating said stopping criteria; and
iterating sequence (a) through (g) using said updated solution strategy and updated space tube and subspace as inputs to said computational process until said stopping criterion is met.

22. The method for simulation/optimization of claim 21 wherein:
said simulation computational process includes a tabu search optimizer.

23. The method for simulation/optimization of claim 21 wherein:
said simulation computational process includes a simulated annealing optimizer.

24. The method for simulation/optimization of claim 21 wherein:
said simulation computational process includes a branch and bound search optimizer.

25. The method for simulation/optimization of claim 21 wherein:
said simulation computational process includes an evolutionary algorithm optimizer.

26. The method for simulation/optimization of claim 25 wherein:
said evolutionary algorithm optimizer includes a genetic algorithm.

27. The method for simulation/optimization of claim 25 wherein:
said evolutionary algorithm optimizer includes genetic programming.

28. The method for simulation/optimization of claim 25 wherein:
said evolutionary algorithm optimizer includes evolutionary strategies.

29. The method for simulation/optimization of claim 21 wherein:
said surrogate simulation process includes a statistical regression equation.

30. The method for simulation/optimization of claim 21 wherein:
said surrogate simulation process includes an artificial neural network.

31. The method for simulation/optimization of claim 21 wherein:
said surrogate simulation process includes a hybrid.

32. The method for simulation/optimization of claim 21 wherein:
updating said multi-dimensional space tube and subspace by computing a modified multi-dimensional space tube and subspace that lengthens in the direction of the optimal solution.

33. The method for simulation/optimization of claim 21 wherein:
updating said multi-dimensional space tube and subspace by computing a modified multi-dimensional space tube and subspace that decreases a space tube radius.

34. The method for simulation/optimization of claim 21 wherein:
updating said multi-dimensional space tube and subspace by computing a modified multi-dimensional space tube and subspace that increases a space tube radius.
